(19) United States
(12) Patent Application Publication
(10) Pub. No.: US 2006/0259484 A1
(43) Pub. Date: Nov. 16, 2006

(54) Computerized group problem solving system

(76) Inventor: Terry K. Gilliam, North Kingstown, RI (US)

Correspondence Address: DEVINE, MILLIMET & BRANCH, P.A., 111 AMHERST STREET, BOX 719, MANCHESTER, NH, 03105, US

(21) Appl. No.: 11/432,748

(22) Filed: May 11, 2006

Related U.S. Application Data
(60) Provisional application No. 60/679,829, filed on May 11, 2005.

(51) Int. Cl. G06F 17/30

(52) U.S. Cl. 707/5

(57) ABSTRACT

A computer based system for groups innovatively to solve problems. The system permits each member of the group to participate in the group asynchronously. Each member participates in any problem solving activity at any time, for any period of time, and for any number of times, as chosen by the member, within the time period allotted to the activity.

### CROSS-REFERENCE TO RELATED APPLICATIONS

The present application claims the benefit of provisional patent application Ser. No. 60/679,829 filed May 11, 2005, which is incorporated herein by reference.

### TECHNICAL FIELD

The present invention relates to computerized group problem solving. More specifically, it relates to a system of computerized group problem solving that allows each member of the group to participate at a different time, for a different period of time, and for a different number of times.

### BACKGROUND OF THE INVENTION

There are a number of systematic methodologies for spurring innovation and problem solving in a group, i.e., an assembly of persons for a specific purpose. These methodologies have traditionally required all members of the group to be physically present in the same room at the same time. This requirement allows only one person in the group to speak at a time. It also leads to limitations on the number of persons in the group, on the number of specific areas of the problem that may be investigated at any given time, on the risk-taking of persons due to lack of anonymity, and on the number of problem solving groups in which any one person may participate at a time.

These limitations have been addressed by a computer based group problem solving methodology that allows participation in the group by a larger number of persons, some of whom may be located in remote locations. This methodology is described in U.S. Pat. No. 5,878,214 (the “'214 Patent”), Computer-Based Group Problem Solving Method and System.

The methodology described in the '214 Patent has, nevertheless, other limitations. It allows participation in the meeting by a larger number of persons, in multiple locations. However, it requires extensive coordination to arrange for the participants in the meeting all to be available at the set time for a meeting. Moreover, the '214 Patent requires that all participants have the requisite software installed on their respective computers. It also requires responses from the participants during the meeting, which may be of limited duration because of the larger number of participants all of whom may have other pressing duties. This does not allow the participants time for reflection, which studies have shown leads to more creative responses.

Thus, there is a need for a group problem solving system that does not require the members of the group to participate in such a traditional group meeting. The present invention is a computerized problem solving system that allows each member of the group to participate at a different time, for a different period of time, and for a different number of times.

### SUMMARY OF THE INVENTION

The present invention is directed to a process and system that satisfies the need for computerized group problem solving that provides a formal innovative problem solving methodology; allows participation by large numbers of individuals; permits participants to be in multiple locations; encourages parallel problem solving; and permits individuals to be resources of multiple problem solving teams. Most importantly, it permits each member of the group to participate at any time, for any period of time, and for any number of times during the time period set for any activity that is part of the process.

The system of present invention allows each member of the problem solving group to use a computer with a “web-browser” to access the system. A group participant list is created, for which one or more members are designated as the client and the remaining members are designated as resources. An agenda is automatically created by an animated agent, which can be customized by the client. Once an agenda is created, responses are gathered from the resources regarding the problem to be solved. These responses, called springboards, are distributed among the members and are available to the members for elaboration and building. Resources are polled about the springboards holding the greatest potential to resolve the problem or opportunity, and voting results are distributed among the members. Based on this polling information, beginning ideas are chosen by the client for further action. Resources offer action oriented ideas about how to accomplish the beginning ideas, and one or more action oriented ideas are selected to be developed by the group into emerging ideas. Resources generate a list of the pluses of each emerging idea and a list of concerns of each emerging idea. After further exchanges to resolve concerns, some of the emerging ideas are selected by the client as possible solutions based on several criteria, and a list of actions is generated in order to implement the selected emerging ideas.

### BRIEF DESCRIPTION OF THE DRAWINGS

These and other features and advantages of the present invention will become better understood by reading the following detailed description taken together with the accompanying drawings wherein preferred embodiments are shown as follows:

FIG. 1 shows a flowchart of a preferred embodiment of the present invention, and

FIG. 2 shows a flow chart of the polling activity in the preferred embodiment of the present invention shown in FIG. 1.

### DETAILED DESCRIPTION OF THE INVENTION

The present invention requires each member of the group to have a computer with an internet “browser,” such as Microsoft's Outlook or Mozilla's Firefox. The members' computers access the present system's website, which term is used herein to include the web application that is the software for the system. Prior art systems, such as that described in the '214 Patent, required the participants' systems to be networked together and to download a “plug-in” that made it appear as though the system was running on each participant's computer when, in fact, only the interface was downloaded.

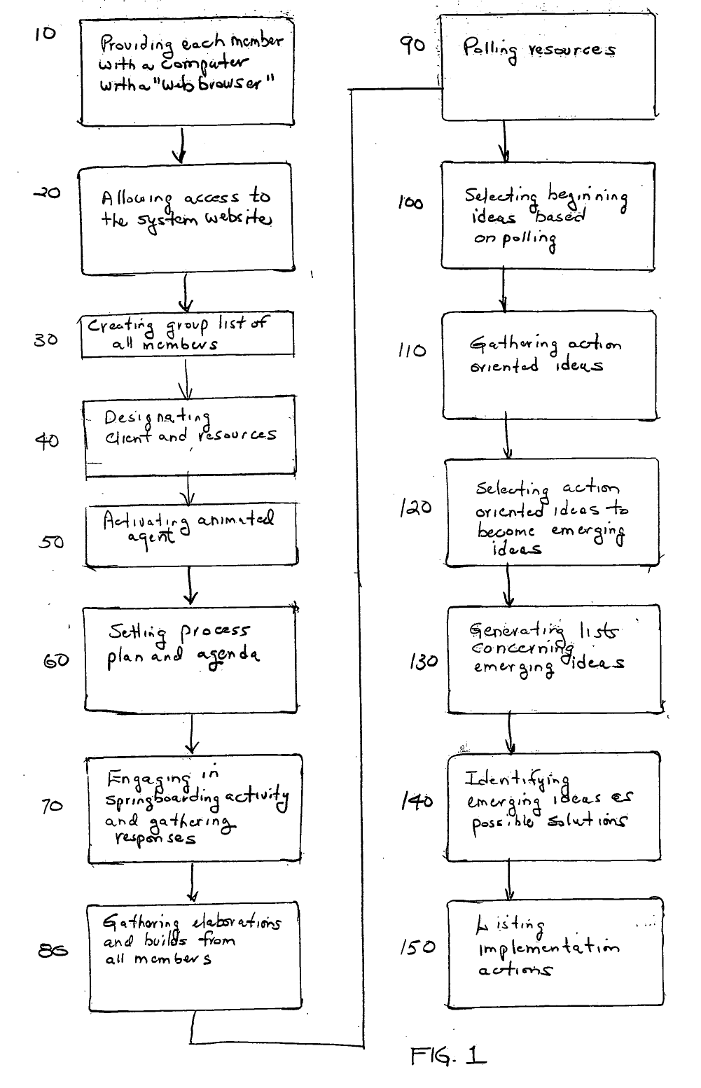

As shown in FIG. 1, a preferred embodiment of the process of the present invention involves the steps described below. Each member of the group has a computer running an internet “browser” in block 10. Often the group participants have access to their own computers running a “browser” at their desks or homes.

Each of the members' computers then uses its “browser” to access the system website in block 20. Typically a member can be notified by email to do so by an email containing instructions on how to do so and a time period within which to do so. The members, as in the prior art, are not limited by geography. In addition, in the present system they are not limited by having to do so at the same time. Each member may access the website at any time during the time period set for an activity as described below. Moreover, each member may so access the website and participate in the various activities of the present group problem solving system at any time, for any period of time and for any number of times as selected by the member, constrained only by the requirement that such access and participation occur during the time period specified for the activity. Members may be notified of start and stop times and may be alerted to approaching stop times, all via emails initiated by the system.

Once all members access the system website, a group list of all members is created in block 30. This group list allows the present system to keep track of everyone participating in the problem solving process. The group then designates one or more members as the client, who is the owner of, or primarily responsible for, the problem to be resolved, and the remaining members are designated as resources in block 40.

The client then, in block 50, chooses an animated agent from those provided by the present system. The agent may be any one of many animated agents that appear by streaming video or other technology. The client will be able to select the agent whose “persona” and skills are preferred for the meeting at hand. The agent acts in the important role of process planner and mediator to move the problem solving process along the steps to a successful conclusion.

Next in block 60, the agent sets the process plan and an agenda for the meeting. This agenda comprises of placeholders, activities, and in the case of asynchronous meetings or activities, the time of, and time period for, each activity. Placeholders are reminders to the group of the various activities taking place. One example of such a placeholder is the task headline. The task headline reminds the group of the focus of the meeting. This task headline is typically one sentence long. Task headlines are but one example of placeholders, and placeholders may be used for any type of reminder to the group and may be scattered through the agenda. The possible activities include an analysis highlight, which provides participants with specific information about the task headlines. Other activities include gathering responses to the problem (this activity is also known as springboarding), gathering comments about and elaborations upon the responses, polling resources' opinions, selecting of beginning ideas, gathering action oriented ideas, selecting emerging ideas, responding to the pluses and minuses of emerging ideas, identifying possible solutions, and listing actions for implementation. The activities used in any group problem solving meeting may include at least two of the problem solving activities that are described in blocks 70-150. The agent communicates the agenda to the resources. In the case of synchronous meetings, the agent also notifies the client and the resources in advance of the expiration of the time period allocated to each activity so that they make timely responses.

The first activity that may be included is that of gathering response to the problem, sometimes called springboarding in block 70. This response gathering activity consists of members entering ideas, thoughts, connections, options, analogies, and the like, sometimes known as springboards, into their computers and these springboards are displayed on other members' computers. In this manner, all members of the problem solving group may be active at the same time or at different times. This problem solving activity and each problem solving activity, maybe scheduled for a particular time period, which scheduling is set by, and communicated to, the members by the agent. Each member may engage in the activity at any time, for any period of time, and for any number of times, during that time period. The critical aspect of the agenda is that the process flow is controlled by the agent.

The gathering of responses activity in block 70 leads to the activity of gathering elaborations and builds from all members in block 80. These comments may reflect concerns or refinements of the responses previously gathered from the resources in block 70. This accumulation of feedback is displayed on all members' computer monitors, just as such a list of responses was generated and displayed in block 70. Each member may, again, add comments and review comments at any time and from time to time during the time period set for this activity. The extended time periods allowed by the present process, and the opportunity for repeatedly reviewing comments and refining comments, should lead to more creative ideas.

Another activity is the polling of resources in block 90. This is a poll concerning the various comments previously submitted. Eight different polling methods are envisioned in this embodiment of the invention although numerous other polling methods will also work. Polling may be by rank order, whereby each resource lists the comments in order of preference. Polling may be based on a ten point scale where each comment is given a score of one to ten. Also, resources may choose a set number of selections from the comments as their comments of choice. Resources may vote yes or no or true or false to each comment. Resources may indicate their degree of agreement with a comment on a four or five point scale. A custom method of polling may also be used, including evaluating each comment against specific criteria established by the client and problem solving team before the meeting began. Regardless of which polling method is chosen, it is the agent who selects, and conducts, the polling method that is used, as described in detail below. Once the polling of resources is complete the results of the poll may be displayed in a number of matrix, graphical or tabular forms. Such forms include bar charts, line charts, pie charts, two and three dimensional graphs or tables. Polling results may also be exported to other applications for analysis. Polling results are available for display to all members.

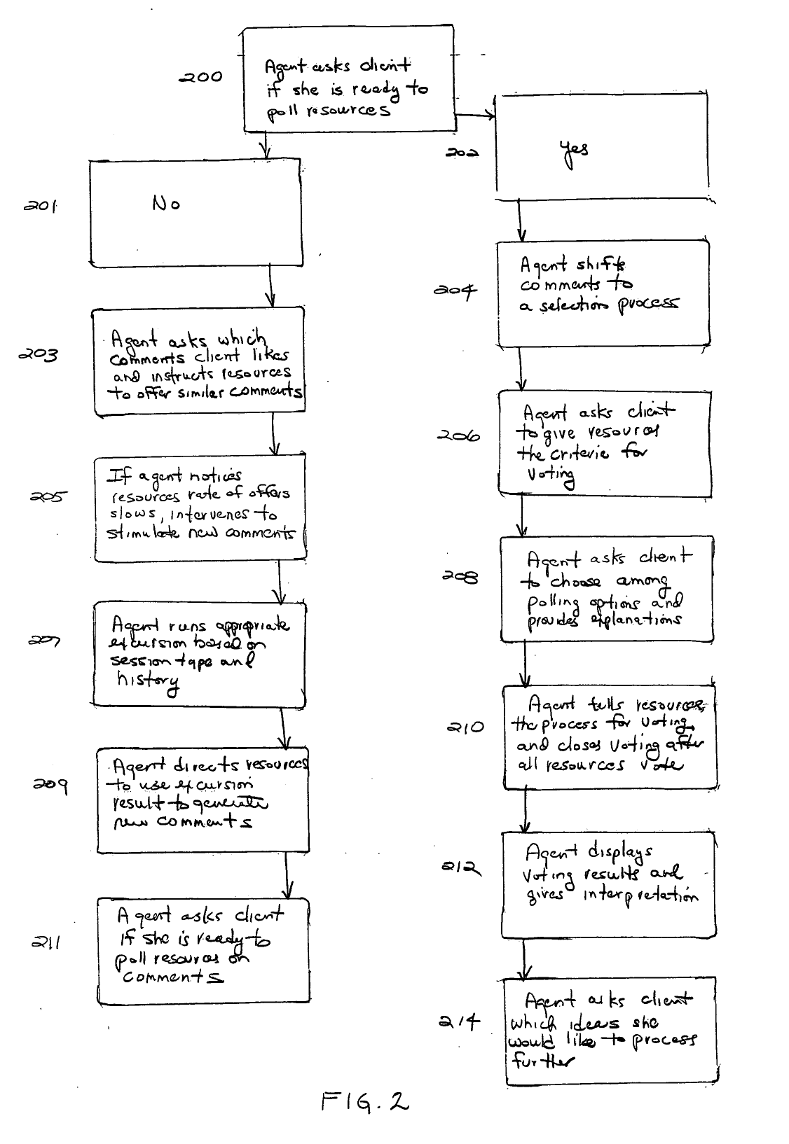

The actions of the agent in controlling the process flow in the process of the present invention can best be appreciated by reviewing the agent's actions in polling as shown in FIG. 2. The agent asks the client if she is ready to poll the resources on the comments submitted by the resources in block 200. If the client responds “no” in block 201, the agent asks which comments the client likes best and instructs the resources to submit similar comments, prompting them with action verbs in block 203. If the resource's rate of offers slows below a set rate, the agent intervenes to stimulate additional new ideas in blocks 205, 207 and 209. The agent then asks the client if she is ready to vote on the ideas submitted in block 211. If the client responds in the negative, the agent repeats the process described above until the client has appealing comments from which to select.

If the client responds “yes” to the agent's query in block 202, the agent shifts the submitted ideas to a selection tool in block 204 and prompts the client to give the resources the criteria they should use for voting in block 206. The agent then asks the client to choose from the available polling options, and, if requested by the client, provides explanations of the polling options in block 208. The agent then tells the resources the process for voting and closes the voting after all the resources have voted in block 210 and displays the results of the voting and gives an interpretation of the results in block 212. Finally, the agent asks the client which ideas she would like to process further and proceeds to the appropriate activity to do so in block 214.

Returning to FIG. 1, in another problem solving activity, shown in block 100, beginning ideas to solve the problem are selected by the client based on the result of a poll. The client decides which of the comments will become beginning ideas. The beginning ideas are distributed to all members for viewing on their personal monitors.

Another problem solving activity is the gathering of action oriented ideas from the resources in block 110. The gathering of these action oriented ideas is similar to the gathering of responses in block 70. All resources enter their action oriented ideas on their computers, with each of these ideas distributed to all members' computers. The agent determines the scheduling and length of time of this activity, based on feedback from the client.

Another problem solving activity, shown in block 120, is selecting a number of action oriented ideas to become emerging ideas. The selection process can be accomplished through the use of polling as performed in block 90 or through a less formal process. This emerging ideas list is distributed to all members of the group.

Another problem solving activity in this embodiment is to imagine each emerging idea in action and then to generate three lists in block 130. One list will consist of pluses of each emerging idea. The second list will be a list of concerns or drawbacks, of each emerging idea. Resources enter their thoughts or ideas, as appropriate, on each of these lists with the lists being viewed by all members on their computer monitors. The third list consists of modifications to an emerging idea, which modifications are based upon the ideas generated to overcome any concerns associated with an emerging idea. The agent determines the scheduling and timing of this list generation process. As with all aspects of this invention, this is an anonymous process that will generate more candid feedback.

At this point in time, the client engages in the problem solving activity, as shown in block 140, of identifying one or more emerging ideas, which are modified to incorporate the results of the group's work to overcome concerns, as possible solutions to the problem being solved. The possible solutions should be new, feasible and there must be commitment among the resources to implement the solution.

In yet another problem solving activity, the resources generate a list of implementation actions in block 150. These are concrete steps to implement the solutions found in block 140. Block 140 established the final buy-in by the resources of the process and solutions, and block 150 acts to hold the resources accountable for actually implementing the ideas.

It should be noted that in other embodiments of the process and system of the present invention, the problem solving activities selected may be undertaken in a different order, as may the other steps show in FIG. 1.

It should also be noted that a critical part of this innovative problem solving process is the use of excursions. Excursions are used to aid in the generation of ideas based on high newness and intrigue, i.e. creative and novel ideas. Excursions can be used at any point in the problem solving processes when the resources capacity for generating new ideas has run dry, when more speculative ideas are wanted by the client or when a breakthrough is needed. For instance, an excursion might be entered into during the springboard activity, the ways and means activity (action ideas) or when generating ideas to overcome concerns. Excursions relax the resources strong internal censoring mechanisms and help them take a mental vacation from the problem at hand.

The excursion activity is a three step process. First, the problem being worked on is temporarily put out of the minds of the client and the resources. Second, the agent focuses the resources upon one or more topics disconnected from the problem being solved. The disconnected topic may be presented in the form of a keyword from a world unrelated to the problem or by focusing a member's attention on an object unrelated to the problem or by giving the members a new identity from which to think about the problem or by guiding them into imagery from which they bring back new material to associate with the problem, among other options. The material has no apparent relation to the problem at hand and is used to provoke associations and thoughts from the resources. The resources will generate a list of associations based on this material that are seemingly irrelevant to the problem at hand. Third, the resources look for connections or clues in the list of associations that help to generate novel ideas to solve the problem. An embodiment of the present invention encompasses the excursion activity and has a built in list of keywords, images, objects and identities for possible excursions. The agent chooses from the list or from any material available on the World Wide Web.

Various changes coming within the spirit of the invention may suggest themselves to those skilled in the art; hence the invention is not limited to the specific embodiment shown or described, but the same is intended to be merely exemplary. It should be understood that numerous other modifications and embodiments can be devised by those skilled in the art that will fall within the spirit and scope of the principles of the invention.

What is claimed is:

1. A computer-based process of innovative problem solving using a group having a plurality of members, said method comprising:
having each member of said group use a computer with a web browser to access a website implementing said method;
creating a group list of all of said members of said group;
designating one or more members of said group as a client who is the owner of, or is primarily responsible for, a problem to be resolved;
designating the remaining members as resources;
activating an animated agent to control process flow, including an agenda, said agenda consisting of placeholders, activities, and times and time allocated for the activities;
engaging in at least two problem solving activities from the group of problem solving activities consisting of:
stimulating and gathering creative responses from said members regarding a problem to be solved, said creative responses entered by said members into said members' computers and distributed throughout said group;
gathering, builds and elaborations from said members upon said responses, said builds and elaborations entered by said members into said members' computers and distributed throughout said group;
polling said members' opinions about said responses, builds and elaborations, said polling accomplished through said members entry of said opinions into said members' computers;
selecting one or more beginning ideas from said responses, builds and elaborations for further action, said beginning ideas selected on the basis of high newness and intrigue by entry by said members into said members' computers and distributed throughout said group;
gathering action oriented ideas to accomplish said beginning ideas, said action oriented ideas entered by said members into said members' computers and distributed throughout said group;
selecting one or more of said action oriented ideas to become one or more emerging ideas, said action oriented ideas selected by entry by said members into said members' computers and distributed throughout said group;
responding to said emerging ideas, said response in the form of a first and a second list, said first list identifying the pluses of said emerging ideas and said second list identifying concerns about said emerging ideas, said first list and said second list gathered through entry of said responses into said members' computers and distributing said responses throughout said group; and
identifying one or more emerging ideas as possible solutions based on newness, feasibility, and commitment of said group to implement action; and listing actions and assigning accountability and time lines to be taken to implement said possible solutions;
wherein said members may participate in any problem solving activity at any time, for any period of time, and for any number of times, during the time period allocated to said activity.

2. The computer-based process of innovative problem solving of claim 1, further comprises the use of excursions wherein said excursion, comprises the steps of: putting the problem being worked on temporarily out of the minds of the members; directing the member to focus on one or more unrelated topics and to create a list of associations and thoughts based on said unrelated topic; and looking for clues in the list of associations to help generate novel ideas to solve said problem.

3. The computer-based process of innovative problem solving as claimed in claim 2, wherein said unrelated topics comprise keywords unrelated to the problem being solved.

4. The computer-based process of innovative problem solving as claimed in claim 2, wherein said unrelated topics comprise objects unrelated to the problem being solved.

5. The computer-based process of innovative problem solving as claimed in claim 2, wherein said unrelated topics comprise new identities for the members from which to address the problem being solved, said new identities unrelated to the problem being solved.

6. The computer-based process of innovative problem solving of claim 1, wherein establishing said agenda further comprises:
creating one or more task headlines to become a focus for said meeting; and
creating a set of analysis highlights, said highlights providing said members with specific information required to generate creative thought and connections about said task headlines.

7. The computer-based process of innovative problem solving of claim 1, wherein said selection process comprises ranking said responses, based on high newness and intrigue, in order of preference and displaying said rankings in a form selected from the group consisting of matrixes, graphs and tables.

8. The computer-based process of innovative problem solving of claim 1, wherein said selection process comprises rating said responses on a scale of one to ten and displaying said ratings in a form selected from the group consisting of matrixes, graphs and tables.

9. The computer-based process of innovative problem solving of claim 1, wherein said selection process comprises indicating the extent of agreement on a five point scale and displaying voting results in a form selected from the group consisting of matrixes, graphs and tables.

10. The computer-based process of innovative problem solving of claim 1, wherein said selection process comprises voting yes or no on each response.

11. The computer-based process of innovative problem solving of claim 1, wherein said selection process comprises selecting one or more responses and displaying voting results in a form from the group consisting of matrixes, graphs and tables.

12. A computer-based system of innovative problem solving using a group having a plurality of members in a computerized meeting comprising:
at least two computers with web browsers;
a means for said computers to access a website implementing the system;
an animated agent for establishing a process plan and an agenda for said meeting; said agenda consisting of placeholders, activities, times and time periods allocated for the activities;
a computerized means to engage in at least two problem solving activities from the group of problem solving activities existing of:
a computerized means for gathering creative response about said problem from said members;
a computerized means for gathering builds and elaborations about said responses from said members;
a computerized means for polling said members' opinions about said responses, builds and elaborations;
a computerized means for selecting beginning ideas based on said members' opinions;
a computerized means for gathering action oriented ideas to accomplish said beginning ideas;
a computerized means for selecting one or more of said action oriented ideas to become emerging ideas;
a computerized means of responding to said emerging ideas with pluses and concerns;
a computerized means of identifying emerging ideas as possible solutions; and
a computerized means of generating a list of actions to be taken, accountabilities and time lines to implement said possible solutions;
wherein said members may participate in any activity at any time, for any period of time, and for any number of times during the time period allotted to the activity.

13. The computer system for innovative problem solving of claim 12, further comprising a means to allow members to engage in excursions to aid in the generation of creative and novel ideas at any point in the problem solving process when the members' capacity for generating new ideas has diminished.
